(19) United States
(12) Patent Application Publication
(10) Pub. No.: US 2015/0073678 A1
(43) Pub. Date: Mar. 12, 2015

(54) BRAKING FORCE CONTROL DEVICE

(71) Applicant: TOYOTA JIDODHA KABUSHIKI KAISHA, Toyota-shi, Aichi (JP)

(72) Inventors: Satoshi Shimizu, Susono-shi (JP); Yoshinori Watanabe, Gotenba-shi (JP)

(73) Assignee: TOYOTA JIDODHA KABUSHIKI KAISHA, Toyota-shi, Aichi (JP)

(21) Appl. No.: 14/385,359

(22) PCT Filed: Jan. 17, 2013
(86) PCT No.: PCT/JP2013/050842

§ 371 Date: Sep. 15, 2014

(30) Foreign Application Priority Data
Mar. 16, 2012 (JP) 2012-061010

(51) Int. Cl. B60T 8/1761; B60T 8/72; B60T 8/1764

(52) U.S. Cl. CPC B60T 8/17616; B60T 8/1764; B60T 8/72
USPC 701/79; 701/78

(57) ABSTRACT

A braking force control device includes a braking device capable of individually adjusting braking force generated at each wheel of a vehicle; and a control device capable of executing braking force distribution control to individually control the braking force of each of right and left wheels such that slip states of the right and left wheels of the vehicle become equivalent by controlling the braking device. The control device executes the braking force distribution control based on a change rate upper limit of a change rate of lateral braking force deviation which is deviation of the braking force of the right and left wheels, so that there is an effect that behavior of the vehicle can be stabilized.

### FIELD

The present invention relates to a braking force control device.

### BACKGROUND

As a conventional braking force control device, Patent Literature 1 discloses a brake device for vehicle which independently controls braking force of each of right and left rear wheels such that brake force distribution between the front wheel and the rear wheel can approximate an ideal curve based on difference between a maximum front wheel speed and a wheel speed of each rear wheel when a vehicle speed is not lower than a predetermined value and vehicle body deceleration is not lower than a predetermined value.

### CITATION LIST

### Patent Literature

Patent Literature 1: Japanese Patent Application Laid-open No. 10-138895

### SUMMARY

### Technical Problem

The brake device for vehicle disclosed in Patent Literature 1 described above has a room for further improvement regarding stabilization of behavior of the vehicle when tire properties (p-properties) of the right and left wheels of the vehicle are different from each other or when the vehicle travels on a traveling road with different frictional coefficients (road surface p) of a road surface on which the right and left wheels are grounded, a so-called p-split road (straddle road), for example.

The present invention is achieved in view of the above-described circumstances and an object thereof is to provide the braking force control device capable of stabilizing the behavior of the vehicle.

### Solution to Problem

In order to achieve the above mentioned object, a braking force control device according to the present invention includes a braking device capable of individually adjusting braking force generated at each wheel of a vehicle; and a control device capable of executing braking force distribution control to individually control the braking force of each of right and left wheels such that slip states of the right and left wheels of the vehicle become equivalent by controlling the braking device, wherein the control device executes the braking force distribution control based on a change rate upper limit of a change rate of lateral braking force deviation which is deviation of the braking force of the right and left wheels.

Further, in the braking force control device, it is possible to configure that the control device gives priority to control to decrease the braking force of the right and left wheels over control to increase the braking force of the right and left wheels, at the time the change rate of the lateral braking force deviation is higher than the change rate upper limit in the braking force distribution control.

Further, in the braking force control device, it is possible to configure that the control device gives priority to control to increase the braking force of the right and left wheels over control to decrease the braking force of the right and left wheels, at the time the change rate of the lateral braking force deviation is higher than the change rate upper limit in the braking force distribution control.

Further, in the braking force control device, it is possible to configure that the change rate upper limit is lower as deceleration of the vehicle is higher.

Further, in the braking force control device, it is possible to configure that the change rate upper limit is higher as a change rate of the deceleration of the vehicle is higher.

Further, in the braking force control device, it is possible to configure that the change rate upper limit is lower as a travel speed of the vehicle is higher.

Further, in the braking force control device, it is possible to configure that the change rate upper limit is higher as a change rate of lateral motion of the vehicle is higher.

Further, in the braking force control device, it is possible to configure that the change rate upper limit is relatively low at the time a wheel on a side on which the braking force is larger out of the right and left wheels is a wheel on a side in the same direction as a direction of the lateral motion of the vehicle, and is relatively high at the time the wheel on the side on which the braking force is larger out of the right and left wheels is a wheel on a side in a direction opposite to the direction of the lateral motion of the vehicle.

Further, in the braking force control device, it is possible to configure that the change rate upper limit is relatively high at the time motion of the vehicle by the change rate of the lateral braking force deviation is in a direction to cancel the lateral motion of the vehicle, and is relatively low at the time the motion of the vehicle by the change rate of the lateral braking force deviation is in a direction to make the lateral motion of the vehicle larger.

Further, in the braking force control device, it is possible to configure that a wheel of the vehicle which is a control target by the braking force distribution control is the right and left rear wheels of the vehicle, and the change rate upper limit is higher as deviation of wheel speeds of the right and left front wheels of the vehicle is larger or a change rate of the deviation of the wheel speeds is higher.

### Advantageous Effects of Invention

The braking force control device according to the present invention has an effect of stabilizing the behavior of the vehicle.

### BRIEF DESCRIPTION OF DRAWINGS

FIG. 1 is a schematic configuration diagram illustrating a vehicle to which a braking force control device according to a first embodiment is applied.

FIG. 2 is a flowchart illustrating an example of braking force distribution control by an ECU of the braking force control device according to the first embodiment.

FIG. 3 is a flowchart illustrating an example of braking force distribution control by an ECU of a braking force control device according to a variation.

FIG. 4 is a diagram illustrating an example of a change rate upper limit map of a braking force control device according to a second embodiment.

FIG. 5 is a diagram illustrating an example of a change rate upper limit map of a braking force control device according to a third embodiment.

FIG. 6 is a diagram illustrating an example of a change rate upper limit map of a braking force control device according to a fourth embodiment.

FIG. 7 is a diagram illustrating an example of a change rate upper limit map of a braking force control device according to a fifth embodiment.

FIG. 8 is a schematic diagram for illustrating a change rate upper limit of a braking force control device according to a sixth embodiment.

FIG. 9 is a schematic diagram for illustrating the change rate upper limit of the braking force control device according to the sixth embodiment.

FIG. 10 is a diagram illustrating an example of a change rate upper limit map of a braking force control device according to a seventh embodiment.

### DESCRIPTION OF EMBODIMENTS

Embodiments according to the present invention are hereinafter described in detail with reference to the drawings. Meanwhile, the present invention is not limited by the embodiments. Components in the following embodiments include a component easily replaceable by one skilled in the art or a substantially identical component.

### First Embodiment

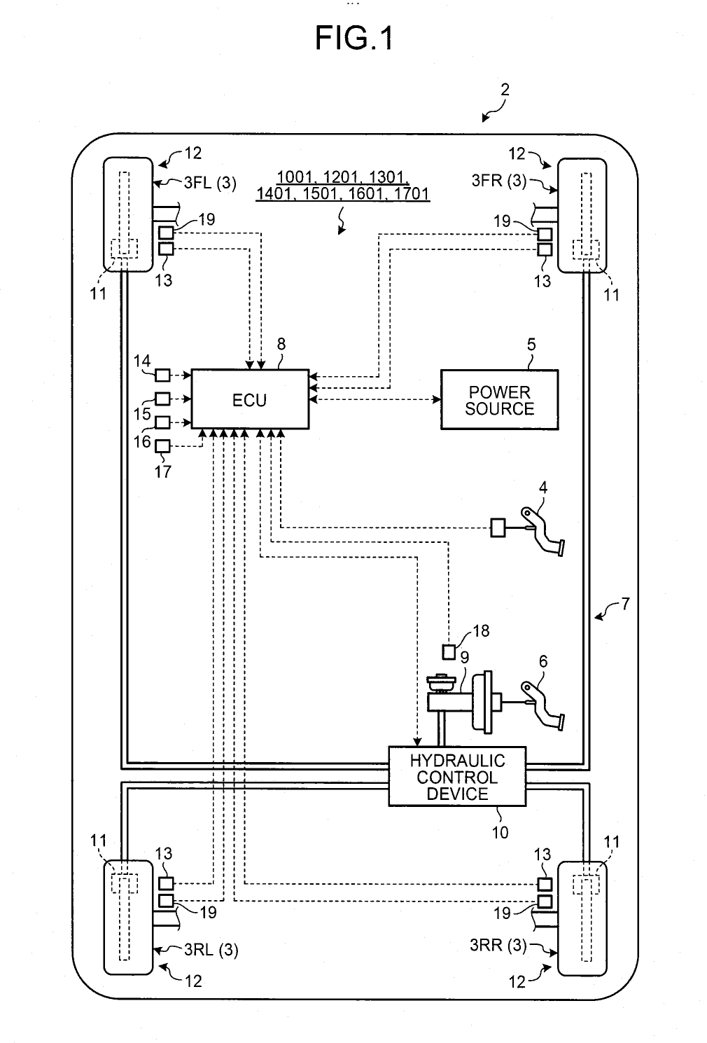

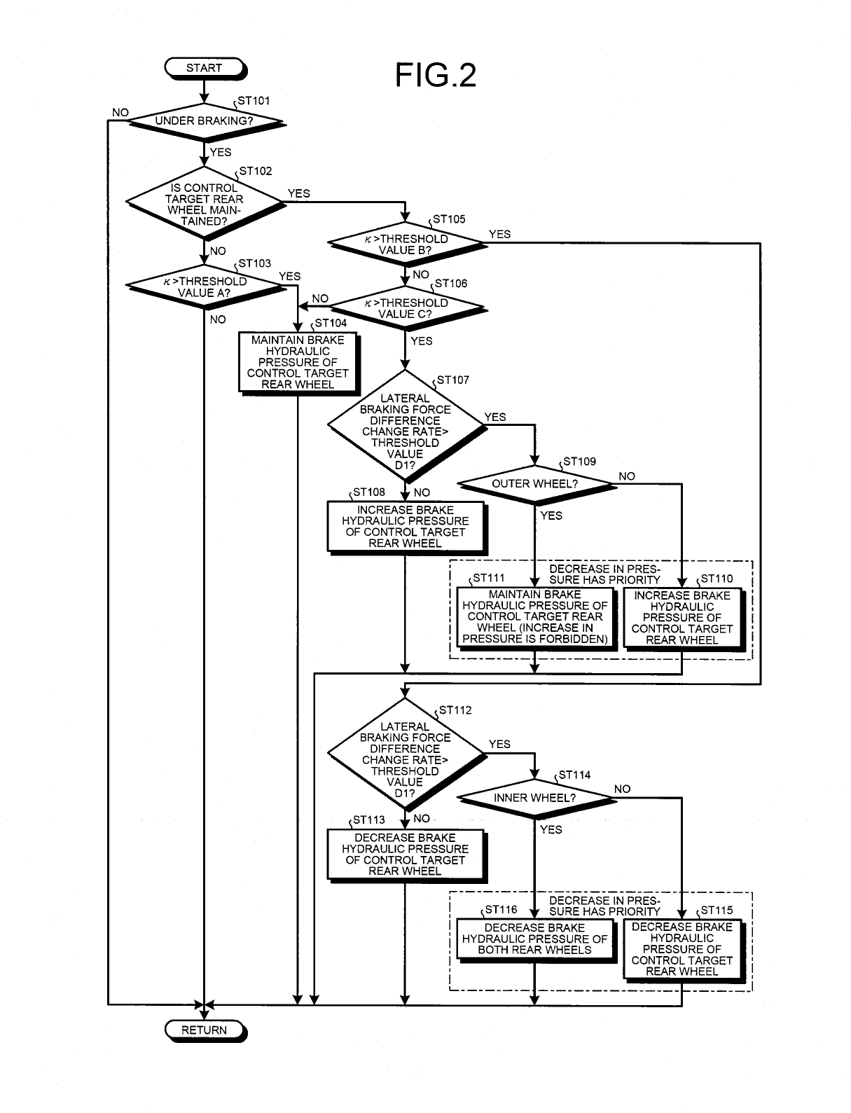

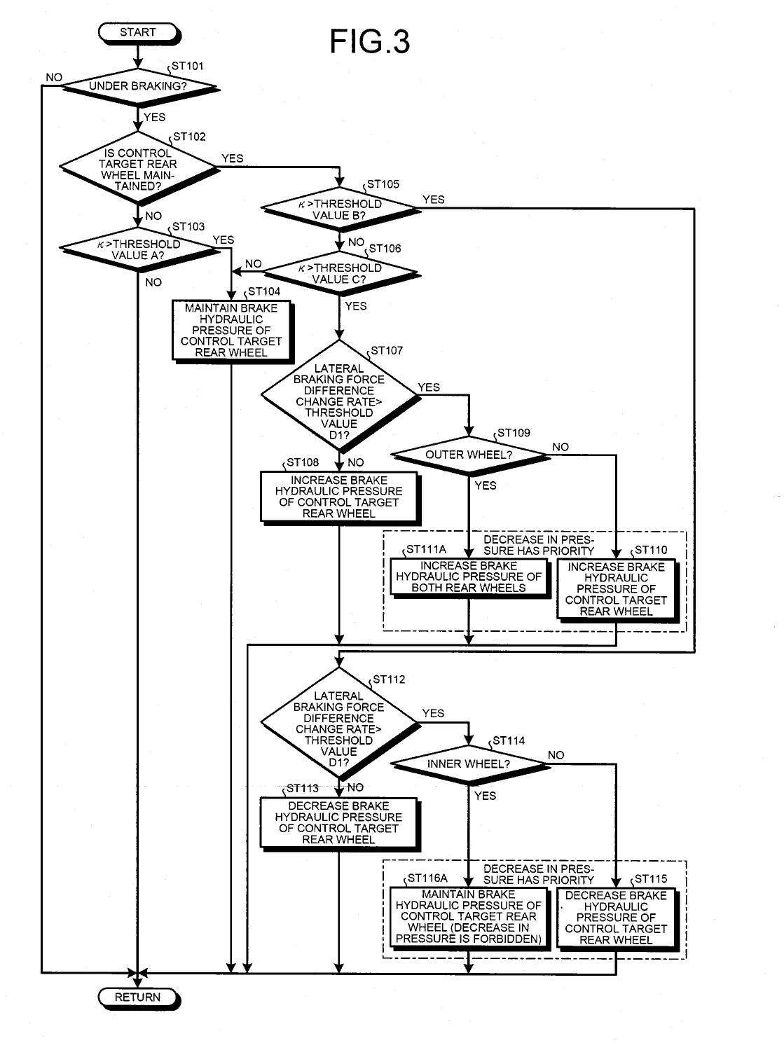

FIG. 1 is a schematic configuration diagram illustrating a vehicle to which a braking force control device according to a first embodiment is applied, FIG. 2 is a flowchart illustrating an example of braking force distribution control by an ECU of the braking force control device according to the first embodiment, and FIG. 3 is a flowchart illustrating an example of braking force distribution control by an ECU of a braking force control device according to a variation.

A braking force control device 1001 of this embodiment illustrated in FIG. 1 is a braking force distribution device capable of executing the braking force distribution control to independently and individually control braking force of each wheel 3 such that slip states (slip ratios) of right and left wheels 3 of a vehicle 2, typically, right and left rear wheels (hereinafter, sometimes referred to as “rear wheels”) 3 of the vehicle 2 are equivalent. The braking force control device 1001 sets a change rate upper limit being an allowed upper limit of a change rate of braking force difference (braking force deviation) between the right and left rear wheels 3 in this braking force distribution control. By this, the braking force control device 1001 tries to stabilize behavior of the vehicle 2 when tire properties (μ-properties) of the right and left wheels 3 of the vehicle 2 are different from each other or when the vehicle 2 travels on a traveling road on which frictional coefficients (road surface p) of a road surface on which the right and left wheels 3 are grounded are different from each other, that is to say, a μ-split road.

When the change rate of the braking force difference becomes higher than the change rate upper limit in the braking force distribution control, the braking force control device 1001 of this embodiment limits the braking force distribution control to prevent an additional increase in the change rate of the braking force difference. In this case, the braking force control device 1001 prevents the additional increase in the change rate of the braking force difference by maintaining the braking force of the right and left wheels 3, giving priority to control to decrease the braking force of the right and left wheels 3 over control to increase the braking force of the right and left wheels 3, or giving priority to the control to increase the braking force of the right and left wheels 3 over the control to decrease the braking force of the right and left wheels 3, for example.

The braking force control device 1001 of this embodiment is a braking control system mounted on the vehicle 2 as illustrated in FIG. 1 for braking the vehicle 2. The braking force control device 1001 typically is the system which stabilizes the behavior of the vehicle 2 by controlling the slip state of each wheel 3 by controlling the braking force generated at the wheel 3 of the vehicle 2.

The vehicle 2 is provided with a left front wheel (wheel 3 on a left front side) 3FL, a right front wheel (wheel 3 on a right front side) 3FR, a left rear wheel (wheel 3 on a left rear side) 3RL, and a right rear wheel (wheel 3 on a right rear side) 3RR as the wheels 3; they are simply referred to as the wheels 3 when it is not especially necessary to distinguish them from each other.

Specifically, the braking force control device 1001 is provided with an accelerator pedal 4, a power source 5, a brake pedal 6, a braking device 7, and an ECU 8 as a control device. In the vehicle 2, the power source 5 generates power (torque) in response to operation of the accelerator pedal 4 by a driver and the power is transmitted to the wheel 3 through a power transmitting device (not illustrated) to generate driving force at the wheel 3. The vehicle 2 generates the braking force at the wheel 3 by operation of the braking device 7 in response to operation of the brake pedal 6 by the driver.

The power source 5 is a power source for travel such as an internal-combustion engine and an electric motor. The braking device 7 can individually adjust the braking force generated at each wheel 3 of the vehicle 2. The braking device 7 includes various types of hydraulic brake device in which a hydraulic route connecting a master cylinder 9 and a wheel cylinder 11 through a hydraulic control device (hydraulic actuator) 10 is filled with brake oil being working fluid. In the braking device 7, a hydraulic braking unit 12 operates according to a braking pressure supplied to the wheel cylinder 11 to generate pressure braking force at the wheel 3. In the braking device 7, basically, a master cylinder pressure (operation pressure) is applied to the brake oil by the master cylinder 9 according to pedal force (operation force) acting on the brake pedal 6 by operation of the brake pedal 6 by the driver. In the braking device 7, a pressure according to the master cylinder pressure acts as a wheel cylinder pressure (braking pressure) in each wheel cylinder 11, so that the hydraulic braking unit 12 operates. In each hydraulic braking unit 12, a brake pad abuts a disk rotor to be pressed against the same, so that predetermined rotational resistance force according to the wheel cylinder pressure acts on the disk rotor rotating together with the wheel 3 and the braking force can be applied to the disk rotor and the wheel 3 rotating integral with the same. During this, in the braking device 7, the wheel cylinder pressure is appropriately adjusted according to a driving state by the hydraulic control device 10.

Herein, the hydraulic control device 10 is configured to individually adjust the braking force generated at each wheel 3 by independently and individually increasing, decreasing, and maintaining the wheel cylinder pressures of the four wheels. The hydraulic control device 10 is provided on the hydraulic route of the brake oil connecting the master cylinder 9 and the wheel cylinder 11 to increase or decrease a fluid pressure in each wheel cylinder 11 by control by the ECU 8 separately from brake operation of the brake pedal 6, thereby controlling the braking force applied to each wheel 3. The hydraulic control device 10 includes a plurality of lines, an oil reservoir, an oil pump, each hydraulic line connected to each wheel cylinder 11 provided on each wheel 3, a plurality of electromagnetic valves for increasing, decreasing, and maintaining the hydraulic pressure of each hydraulic line and the like, for example, to be controlled by the ECU 8. The hydraulic control device 10 serves as working fluid pressure adjusting unit which transmits the hydraulic pressure (master cylinder pressure) in the hydraulic line to each wheel cylinder 11 to be described later directly or after increasing or decreasing the same according to a control instruction of the ECU 8.

The hydraulic control device 10 can adjust the wheel cylinder pressure acting on the wheel cylinder 11 according to an operation amount (step amount) of the brake pedal 6 by the driver by driving of the oil pump and a predetermined electromagnetic valve according to the control instruction of the ECU 8, for example, at the time of normal drive. The hydraulic control device 10 can operate in a pressure increasing mode in which the wheel cylinder pressure acting on the wheel cylinder 11 is increased, a maintaining mode in which this is maintained substantially constant, and a pressure decreasing mode in which this is decreased by the driving of the oil pump and a predetermined electromagnetic valve according to the control instruction of the ECU 8, for example, when the braking force distribution control and the like is executed as described later. The hydraulic control device 10 can individually set the above-described mode for each wheel cylinder 11 of each wheel 3 according to a travel state of the vehicle 2 by the control by the ECU 8. That is to say, the hydraulic control device 10 can individually adjust the braking force acting on each wheel 3 according to the travel state of the vehicle 2 regardless of the operation of the brake pedal 6 by the driver.

The ECU 8 configured to control driving of each unit of the vehicle 2 includes an electronic circuit based on a well-known microcomputer including a CPU, a ROM, a RAM, and an interface. For example, various sensors and detecting devices attached to each part of the vehicle 2 such as each wheel speed sensor 13 which detects a rotational speed of each wheel 3, a longitudinal acceleration sensor 14 which detects acceleration in a longitudinal direction (travel direction) generated in a vehicle body of the vehicle 2, a yaw rate sensor 15 which detects a yaw rate of the vehicle 2, a lateral acceleration sensor 16 which detects acceleration in a lateral direction (direction intersecting with (orthogonal to) the travel direction) generated in the vehicle body of the vehicle 2, a rudder angle sensor 17 which detects a rudder angle of the vehicle 2, a master cylinder pressure sensor 18 which detects the master cylinder pressure, and each wheel cylinder pressure sensor 19 which detects the wheel cylinder pressure of each wheel 3 are electrically connected to the ECU 8 to which electric signals corresponding to detection results are input. The wheel cylinder pressure detected by the wheel cylinder pressure sensor 19 has a value according to magnitude of the braking force generated by the hydraulic braking unit 12 of each wheel 3. The ECU 8 executes a stored control program based on various input signals input from the various sensors and various maps, thereby outputting a driving signal to each unit of the vehicle 2 such as the power source 5 and the hydraulic control device 10 of the braking device 7 to control the driving of them.

The ECU 8 of this embodiment can control the hydraulic control device 10 according to the travel state of the vehicle 2 to individually increase or decrease the wheel cylinder pressure of the wheel cylinder 11 provided on each wheel 3 and individually control the braking force at each wheel 3, thereby realizing a braking force distribution function and the like of the vehicle 2. The ECU 8 is capable of executing the braking force distribution control and the like to individually control the slip state of the wheel 3 by controlling the braking device 7 as control to stabilize the behavior of the vehicle 2. According to this, the braking force control device 1001 can control the behavior of the vehicle 2.

The ECU 8 of this embodiment executes the braking force distribution control to individually control the braking force of each of the right and left wheels 3 such that the slip states of the right and left wheels 3 of the vehicle 2 are equivalent by controlling the braking device 7 as described above. The ECU 8 adjusts the wheel cylinder pressure (hereinafter, sometimes simply referred to as “brake hydraulic pressure”) of each wheel 3 to control the braking force generated at each wheel 3, thereby controlling the slip state of the wheel 3, for example, the slip ratio of the wheel 3 in the braking force distribution control. Herein, the slip ratio is an index indicating a slip (skid) of a tire of the wheel 3 on the road surface. The ECU 8 typically controls the hydraulic control device 10 of the braking device 7 to independently and individually control the brake hydraulic pressures of the right rear wheel 3RR and the left rear wheel 3RL such that the slip ratios of the right rear wheel 3RR and the left rear wheel 3RL being the right and left rear wheels are equivalent.

In the braking force distribution control, the ECU 8 basically individually controls the brake hydraulic pressures of the left rear wheel 3RL and the right rear wheel 3RR such that the slip ratios of the left rear wheel 3RL and the right rear wheel 3RR reach target slip ratios in the braking force distribution control. According to this, the ECU 8 controls braking force distribution of each wheel 3, thereby controlling the braking force generated at the left rear wheel 3RL and the right rear wheel 3RR. The ECU 8 increases the brake hydraulic pressure to increase the braking force when an actual slip ratio becomes smaller than the target slip ratio while decreasing the brake hydraulic pressure to decrease the braking force when the actual slip ratio becomes larger than the above-described target slip ratio in each of the left rear wheel 3RL and the right rear wheel 3RR. The ECU 8 can periodically repeat this to control such that the slip ratios of the left rear wheel 3RL and the right rear wheel 3RR are equivalent, thereby improving stability of the vehicle 2.

Meanwhile, the target slip ratio is set according to the slip ratio equivalent to actual slip ratios of a left front wheel 3FL and a right front wheel 3FR when the braking device 7 generates the braking force at each wheel 3 in response to the brake pedal 6 by the driver, for example. The target slip ratio may have a predetermined range. The ECU 8 may obtain the slip ratio of the wheel 3 by using various well-known methods, for example, by obtaining the slip ratio of each wheel 3 based on a wheel speed of the wheel 3 and a vehicle speed being a travel speed of the vehicle 2. As an example, the ECU 8 obtains a slip ratio κ by using following equation (1) based on a wheel speed Vw of each wheel 3 detected by each wheel speed sensor 13 and a vehicle speed Vr of the vehicle 2 estimated from the wheel speed Vw of each wheel 3. The slip ratio κ is calculated so as to correspond to each wheel 3 based on each detection value by each wheel speed sensor 13. Meanwhile, the above-described vehicle speed may also be detected by a vehicle speed sensor provided separately from each wheel speed sensor 13.

κ=(Vr−Vw)/Vr (1)

Meanwhile, in this case, making the slip ratios of the left rear wheel 3RL and the right rear wheel 3RR equivalent to the slip ratios of the left front wheel 3FL and the right front wheel 3FR, respectively, by the braking force distribution control in the above-described manner corresponds to making the wheel speeds of the left rear wheel 3RL and the right rear wheel 3RR equivalent to the wheel speeds of the left front wheel 3FL and the right front wheel 3FR, respectively.

The ECU 8 of this embodiment executes the braking force distribution control based on the change rate upper limit being the upper limit of the change rate of lateral braking force difference (lateral braking force deviation) (hereinafter sometimes referred to as “lateral braking force difference change rate”) when executing the braking force distribution control. Herein, the lateral braking force difference corresponds to difference (deviation) between the braking force of the left rear wheel 3RL and that of the right rear wheel 3RR. The change rate of the lateral braking force difference corresponds to a change amount of the lateral braking force difference per unit time. The change rate upper limit set for the change rate of the lateral braking force difference between the left rear wheel 3RL and the right rear wheel 3RR is set in advance according to an allowable braking force difference change rate. The change rate upper limit is set in advance according to the slip state of the wheel 3, behavior stability of the vehicle 2 and the like based on actual vehicle evaluation and the like to be stored in a storage unit of the ECU 8. According to this, the braking force control device 1001 can stabilize the behavior of the vehicle 2 even when the tire properties of the right and left wheels 3 of the vehicle 2 are different from each other or when the vehicle 2 travels on the p-split road, for example.

For example, the behavior of the vehicle 2 might be disturbed when the tires having the different tire properties are mounted on the left wheel 3 and the right wheel 3 or at the time of p-split road braking in which the frictional coefficients of the road surface on which the right and left wheels 3 are grounded are different from each other. That is to say, there might be a case in which the vehicle 2 cannot obtain appropriate braking force distribution even when the above-described braking force distribution control is executed such that the slip ratios of the left rear wheel 3RL and the right rear wheel 3RR are equivalent when the tire properties of the right and left wheels 3 are different from each other or the frictional coefficients of the road surface on which the right and left wheels 3 are grounded are different from each other. According to this, the vehicle body of the vehicle 2 might deviate by unintended braking force difference. For example, suppose a case in which a high-grip tire (tire with a high p-property) is mounted on the left rear wheel 3RL and a low-grip tire (tire with a low p-property) is mounted on the right rear wheel 3RR. In such a case, when the braking force of the right rear wheel 3RR and that of the left rear wheel 3RL are adjusted such that the slip ratios of the left rear wheel 3RL and the right rear wheel 3RR are equivalent by the above-described braking force distribution control, actual braking force distribution might be [braking force of right rear wheel 3RR]<[braking force of left rear wheel 3RL]. As a result, the braking force distribution might be such that the vehicle 2 further deviates or turns to left by execution of the above-described braking force distribution control.

On the other hand, the ECU 8 executes the braking force distribution control based on the change rate upper limit of the lateral braking force difference change rate of the left rear wheel 3RL and the right rear wheel 3RR as described above. When the lateral braking force difference change rate of the left rear wheel 3RL and the right rear wheel 3RR is higher than the change rate upper limit in the braking force distribution control, the ECU 8 limits the braking force distribution control to prevent the additional increase in the lateral braking force difference change rate.

The ECU 8 of this embodiment gives priority to control to decrease the braking force of the left rear wheel 3RL and the right rear wheel 3RR over the control to increase the braking force of the left rear wheel 3RL and the right rear wheel 3RR when the lateral braking force difference change rate of the left rear wheel 3RL and the right rear wheel 3RR is higher than the change rate upper limit in the braking force distribution control. That is to say, the ECU 8 preferentially allows the decrease in the brake hydraulic pressures of the left rear wheel 3RL and the right rear wheel 3RR to preferentially decrease the braking force while limiting the increase in the brake hydraulic pressures of the left rear wheel 3RL and the right rear wheel 3RR to prevent the braking force from increasing (stop increasing the braking force) when it is requested to provide the lateral braking force difference at a change rate higher than the change rate upper limit during the execution of the braking force distribution control. In this case, the ECU 8 forbids a braking force increasing request itself when it is requested to increase the braking force of any one of the left rear wheel 3RL and the right rear wheel 3RR and does not output the braking force increasing request or does not increase a braking force request value. The ECU 8 allows a braking force decreasing request when it is requested to decrease the braking force of any one of the left rear wheel 3RL and the right rear wheel 3RR and decreases the braking force request value as usual. According to this, the ECU 8 can limit the braking force distribution control to prevent the additional increase in the lateral braking force difference change rate, thereby limiting the braking force difference within an allowable range.

Meanwhile, when the ECU 8 decreases the brake hydraulic pressures of the left rear wheel 3RL and the right rear wheel 3RR to decrease the braking force in the above-described manner, this limits a decreasing amount of the braking force within a range in which the lateral braking force difference change rate is not higher than the change rate upper limit.

The braking force control device 1001 configured in the above-described manner executes the braking force distribution control based on the change rate upper limit of the lateral braking force difference change rate of the left rear wheel 3RL and the right rear wheel 3RR and limits the braking force distribution control so as to prevent the additional increase in the lateral braking force difference change rate in a state in which the lateral braking force difference change rate of the left rear wheel 3RL and the right rear wheel 3RR reaches the change rate upper limit, for example. Therefore, the braking force control device 1001 can inhibit the lateral braking force difference change rate from becoming the change rate upper limit or higher based on the allowable change rate upper limit when independently adjusting the braking force of the right rear wheel 3RR and that of the left rear wheel 3RL in order to make the slip ratios of the left rear wheel 3RL and the right rear wheel 3RR equivalent in the braking force distribution control. According to this, the braking force control device 1001 can make the lateral braking force distribution appropriate to inhibit the vehicle 2 from deviating and turning by the unintended lateral braking force difference and minimize the vehicle behavior due to the braking force difference, so that the driver can perform corrective steering without a sense of discomfort, for example. As a result, the braking force control device 1001 can minimize occurrence of the disturbance of the behavior of the vehicle 2 also when the tire properties of the right and left wheels 3 of the vehicle 2 are different or when the vehicle 2 travels on the p-split road, for example.

At that time, the braking force control device 1001 preferentially decreases the braking force of the left rear wheel 3RL and the right rear wheel 3RR while not increasing the braking force of the left rear wheel 3RL and the right rear wheel 3RR in a state in which the lateral braking force difference change rate reaches the change rate upper limit. For example, the braking force control device 1001 simultaneously decreases the brake hydraulic pressures of the right rear wheel 3RR and the left rear wheel 3RL to simultaneously decrease the braking force when it becomes necessary to decrease the braking force on an inner wheel side at the time of deviation or turn out of the left rear wheel 3RL and the right rear wheel 3RR (pressure adjustment in a direction in which the lateral braking force difference increases) in a state in which the lateral braking force difference change rate reaches the change rate upper limit. As a result, the braking force control device 1001 can make the slip ratios of the left rear wheel 3RL and the right rear wheel 3RR appropriate while limiting the lateral braking force difference change rate within an allowable range and prevent the left rear wheel 3RL and the right rear wheel 3RR from being locked to certainly secure directional stability and the like of the vehicle 2. Meanwhile, deviating and turning directions of the vehicle 2 are determined according to the lateral braking force difference, the tire properties of the right and left wheels 3, the frictional coefficients of the road surface on which the right and left wheels 3 are grounded and the like, for example, so that an inner wheel and an outer wheel are determined according to this.

Next, an example of the braking force distribution control by the ECU 8 is described with reference to the flowchart in FIG. 2. Meanwhile, a control routine is repeatedly executed with a control period of several ms to tens of ms. The braking force distribution control of this embodiment is individually executed for the left rear wheel 3RL and the right rear wheel 3RR. In the following description, the wheel 3 being a target of the braking force distribution control out of the left rear wheel 3RL and the right rear wheel 3RR is referred to as a control target rear wheel.

The ECU 8 determines whether it is currently under braking based on the detection result by the wheel cylinder pressure sensor 19 and the like (ST101). When the ECU 8 determines that it is not currently under braking (ST101: No), this terminates a current control period and shifts to a next control period.

When the ECU 8 determines that it is currently under braking (ST101: Yes), this determines whether the brake hydraulic pressure of the control target rear wheel is being maintained based on the detection result by the wheel cylinder pressure sensor 19 and the like (ST102).

When the ECU 8 determines that the brake hydraulic pressure of the control target rear wheel is not being maintained (ST102: No), this determines whether the slip ratio κ of the control target rear wheel is larger than a threshold value A based on the detection result of the wheel speed sensor 13 and the like (ST103). The threshold value A is set according to the target slip ratio described above, for example.

When the ECU 8 determines that the slip ratio κ of the control target rear wheel is not larger than the threshold value A (ST103: No), this terminates the current control period and shifts to the next control period. When the ECU 8 determines that the slip ratio κ of the control target rear wheel is larger than the threshold value A (ST103: Yes), this controls the hydraulic control device 10 to maintain the brake hydraulic pressure of the control target rear wheel and maintain the braking force of the control target rear wheel (ST104), then terminates the current control period to shift to the next control period.

When the ECU 8 determines that the brake hydraulic pressure of the control target rear wheel is being maintained at ST102 (ST102: Yes), this determines whether the slip ratio κ of the control target rear wheel is larger than a threshold value B based on the detection result of the wheel speed sensor 13 (ST105). The threshold value B is set according to the target slip ratio described above, for example, as the above-described threshold value A.

When the ECU 8 determines that the slip ratio κ of the control target rear wheel is not larger than the threshold value B (ST105: No), this determines whether the slip ratio κ of the control target rear wheel is smaller than a threshold value C based on the detection result of the wheel speed sensor 13 (ST106). The threshold value C is set according to the target slip ratio described above, for example, as the above-described threshold values A and B. Herein, the threshold value C is set based on predetermined hysteresis relative to the threshold value B in order to inhibit hunting of the control.

When the ECU 8 determines that the slip ratio κ of the control target rear wheel is not smaller than the threshold value C (ST106: No), this shifts to ST104 and controls the hydraulic control device 10 to maintain the brake hydraulic pressure of the control target rear wheel.

When the ECU 8 determines that the slip ratio κ of the control target rear wheel is smaller than the threshold value C (ST106: Yes), this determines whether a current lateral braking force difference change rate of the left rear wheel 3RL and the right rear wheel 3RR is higher than a threshold value D1 based on the detection result of the wheel cylinder pressure sensor 19 and the like (ST107). The threshold value D1 is set according to the above-described upper limit.

When the ECU 8 determines that the current lateral braking force difference change rate of the left rear wheel 3RL and the right rear wheel 3RR is not higher than the threshold value D1 (ST107: No), this controls the hydraulic control device 10 to increase the brake hydraulic pressure of the control target rear wheel to increase the braking force of the control target rear wheel (ST108), then terminates the current control period to shift to the next control period.

When the ECU 8 determines that the current lateral braking force difference change rate of the left rear wheel 3RL and the right rear wheel 3RR is higher than the threshold value D1 (ST107: Yes), this determines whether the control target rear wheel is the outer wheel (ST109). In this case, the ECU 8 gives priority to the decrease in the brake hydraulic pressures of the left rear wheel 3RL and the right rear wheel 3RR and limits the increase in the brake hydraulic pressures, thereby adjusting the brake hydraulic pressures of the left rear wheel 3RL and the right rear wheel 3RR to adjust braking force while limiting the lateral braking force difference change rate within the change rate upper limit in the following control.

Specifically, when the control target rear wheel is not the outer wheel (ST109: No), the ECU 8 controls the hydraulic control device 10 to increase the brake hydraulic pressure of the control target rear wheel (ST110). At that time, the ECU 8 gives priority to the decrease in the brake hydraulic pressure and decrease in the braking force of the wheel other than the control target rear wheel and limits the increase in the brake hydraulic pressure and increase in the braking force of the control target rear wheel when there is a brake hydraulic pressure decreasing request to the wheel other than the control target rear wheel out of the left rear wheel 3RL and the right rear wheel 3RR. According to this, the ECU 8 inhibits the lateral braking force difference change rate from becoming the change rate upper limit or higher.

When the control target rear wheel is the outer wheel (ST109: Yes), the ECU 8 forbids the increase in the brake hydraulic pressure and increase in the braking force regardless of a state of the wheel other than the control target rear wheel out of the left rear wheel 3RL and the right rear wheel 3RR and controls the hydraulic control device 10 to maintain the brake hydraulic pressure of the control target rear wheel and maintain the braking force of the control target rear wheel (ST111), then terminates the current control period to shift to the next control period. According to this, the ECU 8 can minimize the occurrence of the disturbance of the behavior of the vehicle 2 while inhibiting the lateral braking force difference change rate from becoming the change rate upper limit or higher.

When the ECU 8 determines that the slip ratio κ of the control target rear wheel is larger than the threshold value B at ST105 (ST105: Yes), this determines whether the current lateral braking force difference change value of the left rear wheel 3RL and the right rear wheel 3RR is higher than the threshold value D1 based on the detection result of the wheel cylinder pressure sensor 19 and the like (ST112).

When the ECU 8 determines that the current lateral braking force difference change rate of the left rear wheel 3RL and the right rear wheel 3RR is not higher than the threshold value D1 (ST112: No), this controls the hydraulic control device 10 to decrease the brake hydraulic pressure of the control target rear wheel and decrease the braking force of the control target rear wheel (ST113), then terminates the current control period to shift to the next control period.

When the ECU 8 determines that the current lateral braking force difference change rate of the left rear wheel 3RL and the right rear wheel 3RR is higher than the threshold value D1 (ST112: Yes), this determines whether the control target rear wheel is the inner wheel (ST114). In this case, the ECU 8 gives priority to the decrease in the brake hydraulic pressures of the left rear wheel 3RL and the right rear wheel 3RR and limits the increase in the brake hydraulic pressures, thereby adjusting the brake fluid pressures of the left rear wheel 3RL and the right rear wheel 3RR to adjust the braking force while limiting the lateral braking force difference change rate within the change rate upper limit in the following control.

Specifically, when the control target rear wheel is not the inner wheel (ST114: No), the ECU 8 controls the hydraulic control device 10 to decrease the brake hydraulic pressure of the control target rear wheel (ST115). At that time, the ECU 8 limits the increase in the brake hydraulic pressure and increase in the braking force of the wheel other than the control target rear wheel and gives priority to the decrease in the brake hydraulic pressure and decrease in the braking force of the control target rear wheel when there is a brake hydraulic pressure increasing request to the wheel other than the control target rear wheel out of the left rear wheel 3RL and the right rear wheel 3RR. According to this, the ECU 8 inhibits the lateral braking force difference change rate from becoming the change rate upper limit or higher.

When the control target rear wheel is the inner wheel (ST114: Yes), the ECU 8 controls the hydraulic control device 10 to decrease the brake hydraulic pressures of both rear wheels (left rear wheel 3RL and right rear wheel 3RR) to simultaneously decrease the braking force of the both rear wheels (ST116) regardless of the state of the wheel other than the control target rear wheel out of the left rear wheel 3RL and the right rear wheel 3RR, then terminates the current control period to shift to the next control period. According to this, the ECU 8 can minimize the occurrence of the disturbance of the behavior of the vehicle 2 while inhibiting the lateral braking force difference change rate from becoming the change rate upper limit or higher.

The braking force control device 1001 according to the above-described embodiment is provided with the braking device 7 and the ECU 8. The braking device 7 can individually adjust the braking force generated at each wheel 3 of the vehicle 2. The ECU 8 can execute the braking force distribution control to individually control the braking force of each of the right and left wheels 3 such that the slip states of the right and left wheels 3 of the vehicle 2 are equivalent by controlling the braking device 7. Then, the ECU 8 executes the braking force distribution control based on the change rate upper limit of the change rate of the lateral braking force deviation being the deviation of the braking force of each of the right and left wheels 3. Therefore, the braking force control device 1001 can stabilize the behavior of the vehicle 2 by the braking force distribution control also when the tire properties of the right and left wheels 3 of the vehicle 2 are different from each other or when the vehicle 2 travels on the p-split road, for example.

Meanwhile, the ECU 8 described above may further execute the braking force distribution control based on a braking force difference upper limit being an upper limit of the lateral braking force difference (lateral braking force deviation) in addition to the braking force distribution control based on the change rate upper limit described above when executing the braking force distribution control. In this case, the ECU 8 may also execute the braking force distribution control based on the change rate upper limit and the braking force distribution control based on the braking force difference upper limit in parallel, thereby complementing the pieces of control each other.

Although it is described above that the ECU 8 gives priority to the control to decrease the braking force of the left rear wheel 3RL and the right rear wheel 3RR over the control to increase the braking force of the left rear wheel 3RL and the right rear wheel 3RR when the lateral braking force difference change rate of the left rear wheel 3RL and the right rear wheel 3RR is higher than the change rate upper limit in the braking force distribution control, the ECU 8 is not limited to this. In such a case, the ECU 8 may limit the braking force distribution control so as to prevent the additional increase in the lateral braking force difference change rate and may limit the braking force distribution control by maintaining the braking force of the right and left wheels 3 and giving priority to the control to increase the braking force of the right and left wheels 3, for example.

For example, the ECU 8 may also give priority to the control to increase the braking force of the left rear wheel 3RL and the right rear wheel 3RR over the control to decrease the braking force of the left rear wheel 3RL and the right rear wheel 3RR when the lateral braking force difference change rate of the left rear wheel 3RL and the right rear wheel 3RR is higher than the change rate upper limit in the braking force distribution control as illustrated in FIG. 3. That is to say, the ECU 8 preferentially allows the increase in the brake hydraulic pressures of the left rear wheel 3RL and the right rear wheel 3RR to preferentially increase the braking force while limiting the decrease in the brake hydraulic pressures of the left rear wheel 3RL and the right rear wheel 3RR to prevent the braking force from decreasing (stops decreasing the braking force) when it is requested to provide the lateral braking force difference at a change rate higher than the change rate upper limit during the execution of the braking force distribution control. In this case, the ECU 8 forbids the braking force decreasing request itself when it is requested to decrease the braking force of any one of the left rear wheel 3RL and the right rear wheel 3RR, and does not output the braking force decreasing request or does not decrease the braking force request value. The ECU 8 allows the braking force increasing request when it is requested to increase the braking force of any one of the left rear wheel 3RL and the right rear wheel 3RR and increases the braking force request value as usual. According to this, the ECU 8 can limit the braking force distribution control to prevent the lateral braking force difference change rate from becoming higher, thereby limiting the braking force difference within the allowable range.

In this case, when the ECU 8 determines that the current lateral braking force difference change rate of the left rear wheel 3RL and the right rear wheel 3RR is higher than the threshold value D1 at ST107 and ST112 as illustrated in FIG. 3, this gives priority to the increase in the brake hydraulic pressures of the left rear wheel 3RL and the right rear wheel 3RR and limits the decrease in the brake hydraulic pressures in the following control. According to this, the ECU 8 adjusts the brake hydraulic pressures of the left rear wheel 3RL and the right rear wheel 3RR to adjust the braking force while limiting the lateral braking force difference change rate within the change rate upper limit.

Specifically, when the ECU 8 determines that the control target rear wheel is not the outer wheel at ST109 (ST109: No), this controls the hydraulic control device 10 to increase the brake hydraulic pressure of the control target rear wheel (ST110). At that time, the ECU 8 limits the decrease in the brake hydraulic pressure and decrease in the braking force of the wheel other than the control target rear wheel and gives priority to the increase in the brake hydraulic pressure and increase in the braking force of the control target rear wheel when there is the brake hydraulic pressure decreasing request to the wheel other than the control target rear wheel out of the left rear wheel 3RL and the right rear wheel 3RR. According to this, the ECU 8 inhibits the lateral braking force difference change rate from becoming the change rate upper limit or higher.

When the ECU 8 determines that the control target rear wheel is the outer wheel at ST109 (ST109: Yes), this controls the hydraulic control device 10 to increase the brake hydraulic pressures of both rear wheels (left rear wheel 3RL and right rear wheel 3RR) and simultaneously increase the braking force of the both rear wheels (ST111A) regardless of the state of the wheel other than the control target rear wheel out of the left rear wheel 3RL and the right rear wheel 3RR, then terminates the current control period to shift to the next control period. According to this, the ECU 8 can minimize the occurrence of the disturbance of the behavior of the vehicle 2 while inhibiting the lateral braking force difference change rate from becoming the change rate upper limit or higher.

When the ECU 8 determines that the control target rear wheel is not the inner wheel at ST114 (ST114: No), this controls the hydraulic control device 10 to decrease the brake hydraulic pressure of the control target rear wheel (ST115). At that time, the ECU 8 gives priority to the increase in the brake hydraulic pressure and increase in the braking force of the wheel other than the control target rear wheel and limits the decrease in the brake hydraulic pressure and decrease in the braking force of the control target rear wheel when there is the brake hydraulic pressure increasing request to the wheel other than the control target rear wheel out of the left rear wheel 3RL and the right rear wheel 3RR. According to this, the ECU 8 inhibits the lateral braking force difference change rate from becoming the change rate upper limit or higher.

When the ECU 8 determines that the control target rear wheel is the inner wheel at ST114 (ST114: Yes), this forbids the decrease in the brake hydraulic pressure and decrease in the braking force regardless of the state of the wheel other than the control target rear wheel out of the left rear wheel 3RL and the right rear wheel 3RR and controls the hydraulic control device 10 to maintain the brake hydraulic pressure of the control target rear wheel and maintain the braking force of the control target rear wheel (ST116A), then terminates the current control period to shift to the next control period. According to this, the ECU 8 can minimize the occurrence of the disturbance of the behavior of the vehicle 2 while inhibiting the lateral braking force difference change rate from becoming the change rate upper limit or higher.

As a result, the braking force control device 1001 can make the slip ratios of the left rear wheel 3RL and the right rear wheel 3RR appropriate while limiting the lateral braking force difference change rate within the allowable range, and this can increase deceleration when a rear load is large, for example, and certainly secure directional stability and the like of the vehicle 2.

### Second Embodiment

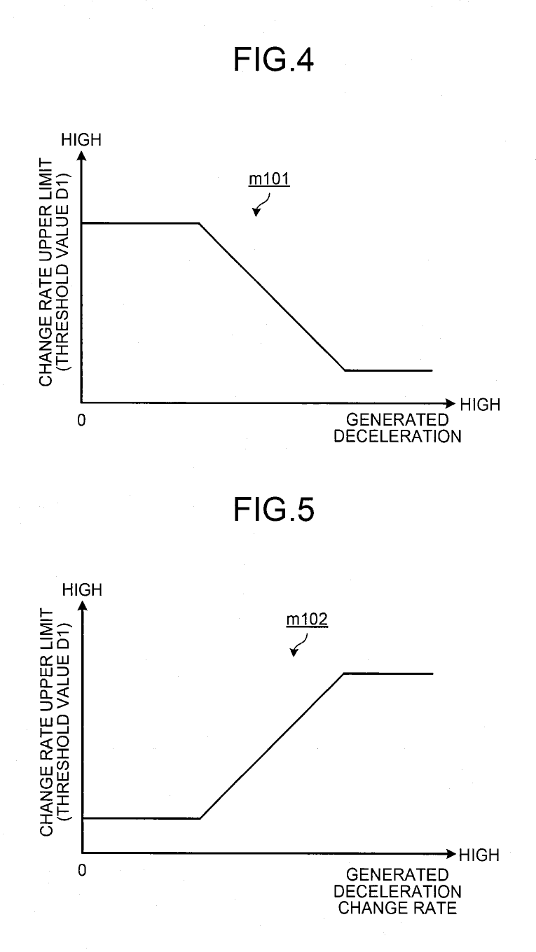

FIG. 4 is a diagram illustrating an example of a change rate upper limit map of a braking force control device according to a second embodiment. The braking force control device according to the second embodiment is different from that of the first embodiment in that a change rate upper limit is changed according to deceleration of a vehicle. A configuration, an action, and an effect the same as those of the above-described embodiment are not repeatedly described as far as possible. Meanwhile, FIG. 1 is appropriately referred to for a detail of each configuration of the braking force control device according to the second embodiment (the same applies to following embodiments).

An ECU 8 of a braking force control device 1201 according to this embodiment (refer to FIG. 1) changes the change rate upper limit according to the deceleration of a vehicle 2. In this embodiment, the change rate upper limit set for a lateral braking force difference change rate of a left rear wheel 3RL and a right rear wheel 3RR is set so as to be lower as the deceleration of the vehicle 2 is higher. Meanwhile, as the deceleration of the vehicle 2 becomes relatively high in a positive (+) direction, a degree of deceleration of the vehicle 2 becomes larger.

Herein, a change rate upper limit map m101 illustrated in FIG. 4 is a map for setting the change rate upper limit (threshold value D1) in which the deceleration generated in the vehicle 2 (hereinafter, sometimes referred to as “generated deceleration”) is plotted along the abscissa and the change rate upper limit is plotted along the ordinate. The change rate upper limit map m101 represents relationship between the generated deceleration and the change rate upper limit. The change rate upper limit map m101 in which the relationship between the generated deceleration and the change rate upper limit is set in advance based on actual vehicle evaluation and the like is stored in a storage unit of the ECU 8. In the change rate upper limit map m101, the change rate upper limit decreases as the generated deceleration increases. The ECU 8 calculates the change rate upper limit of the lateral braking force difference change rate from the generated deceleration (for example, an absolute value) detected by a longitudinal acceleration sensor 14 and the like based on the change rate upper limit map m101. According to this, the ECU 8 can make the change rate upper limit of lateral braking force difference lower as the deceleration of the vehicle 2 is higher.

Meanwhile, although the ECU 8 is described to calculate the change rate upper limit by using the change rate upper limit map m101 illustrated in FIG. 4 in this embodiment, this embodiment is not limited to this. The ECU 8 may also calculate the change rate upper limit based on an equation model corresponding to the change rate upper limit map illustrated in FIG. 4, for example. The same applies to various maps to be described hereinafter.

Herein, behavior sensitivity of the vehicle 2 tends to be relatively high as the generated deceleration is higher.

On the other hand, the braking force control device 1201 configured as described above can appropriately secure stability of the vehicle 2 corresponding to the behavior sensitivity of the vehicle 2 changing according to the generated deceleration by setting the change rate upper limit to a lower value as the generated deceleration is higher. For example, in a high-deceleration region in which relatively large lateral braking force difference is required for directional stability, the braking force control device 1201 can allow the relatively large lateral braking force difference because there is no upper limit set for the lateral braking force difference itself and then inhibit the lateral braking force difference change rate. As a result, the braking force control device 1201 can more certainly stabilize the behavior of the vehicle 2 by the braking force distribution control.

### Third Embodiment

FIG. 5 is a diagram illustrating an example of a change rate upper limit map of a braking force control device according to a third embodiment. The braking force control device according to the third embodiment is different from that of the first and second embodiments in that a change rate upper limit is changed according to a change rate of deceleration of a vehicle.

An ECU 8 of a braking force control device 1301 according to this embodiment (refer to FIG. 1) changes the change rate upper limit according to the change rate of the deceleration of a vehicle 2. The change rate of the deceleration of the vehicle 2 corresponds to a change amount of the deceleration per unit time. In this embodiment, the change rate upper limit set for a lateral braking force difference change rate of a left rear wheel 3RL and a right rear wheel 3RR is set so as to be higher as the change rate of the deceleration of the vehicle 2 is higher.

Herein, a change rate upper limit map m102 illustrated in FIG. 5 is a map for setting the change rate upper limit (threshold value D1) in which the change rate of generated deceleration generated in the vehicle 2 is plotted along the abscissa and the change rate upper limit is plotted along the ordinate. The change rate upper limit map m102 represents relationship between the generated deceleration change rate and the change rate upper limit. The change rate upper limit map m102 in which the relationship between the generated deceleration change rate and the change rate upper limit is set in advance based on actual vehicle evaluation and the like is stored in a storage unit of the ECU 8. In this change rate upper limit map m102, the change rate upper limit increases as the generated deceleration change rate increases. The ECU 8 calculates the change rate upper limit of the lateral braking force difference change rate from the change rate of the generated deceleration (for example, an absolute value) detected by a longitudinal acceleration sensor 14 and the like based on the change rate upper limit map m102. According to this, the ECU 8 can make the change rate upper limit of lateral braking force difference higher as the deceleration change rate of the vehicle 2 is higher.

The braking force control device 1301 configured in the above-described manner sets the change rate upper limit to a higher value as the generated deceleration change rate is higher, that is to say, at the time of sudden braking. According to this, the braking force control device 1301 can provide the lateral braking force difference at a relatively high change rate at the time of the sudden braking. As a result, the braking force control device 1301 can provide the relatively large lateral braking force difference in time by braking force distribution control even at the time of the sudden braking, so that this can certainly stabilize the behavior of the vehicle 2 even at the time of the sudden braking.

### Fourth Embodiment

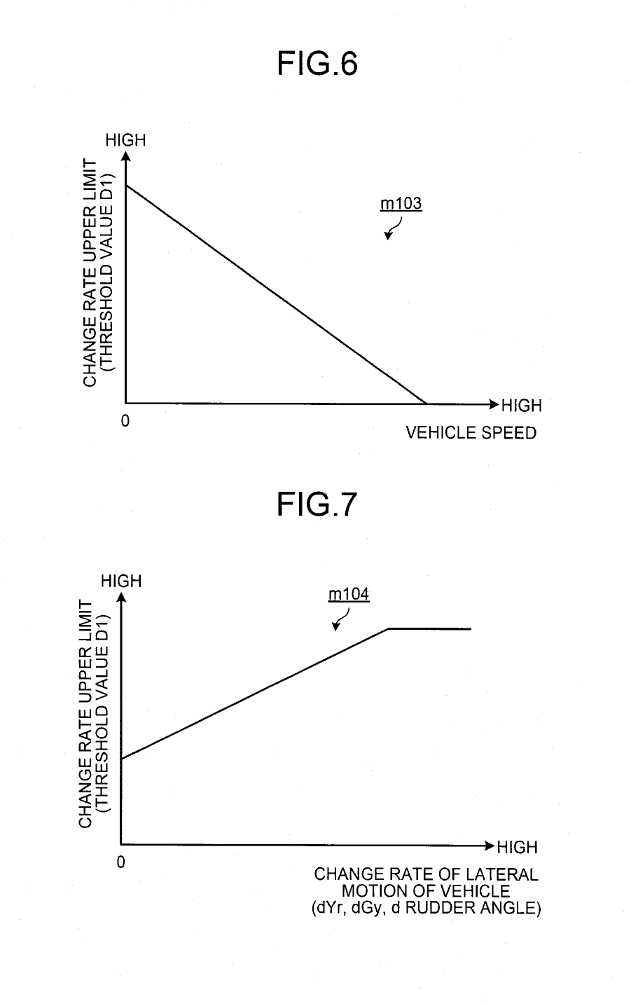

FIG. 6 is a diagram illustrating an example of a change rate upper limit map of a braking force control device according to a fourth embodiment. The braking force control device according to the fourth embodiment is different from that of the first to third embodiments in that a change rate upper limit is changed according to a travel speed of a vehicle.

An ECU 8 of a braking force control device 1401 according to this embodiment (refer to FIG. 1) changes the change rate upper limit according to a vehicle speed being the travel speed of a vehicle 2. In this embodiment, the change rate upper limit set for lateral braking force difference between a left rear wheel 3RL and a right rear wheel 3RR is set so as to be lower as the vehicle speed of the vehicle 2 is higher.

Herein, a change rate upper limit map m103 illustrated in FIG. 6 is a map for setting the change rate upper limit (threshold value D1) in which the vehicle speed of the vehicle 2 is plotted along the abscissa and the change rate upper limit is plotted along the ordinate. The change rate upper limit map m103 represents relationship between the vehicle speed and the change rate upper limit of the lateral braking force difference. The change rate upper limit map m103 in which the relationship between the vehicle speed and the change rate upper limit is set in advance based on actual vehicle evaluation and the like is stored in a storage unit of the ECU 8. In the change rate upper limit map m103, the change rate upper limit of the lateral braking force difference decreases as the vehicle speed increases. The ECU 8 calculates the change rate upper limit of a lateral braking force difference change rate from the vehicle speed estimated from a wheel speed detected by each wheel speed sensor 13 based on the change rate upper limit map m103. According to this, the ECU 8 can make the change rate upper limit of the lateral braking force difference lower as the vehicle speed of the vehicle 2 is higher.

Behavior of the vehicle 2 by unintended lateral braking force difference generated due to difference between tire properties of right and left wheels 3 and μ-split road travel is such that behavior sensitivity to the lateral braking force difference tends to be higher as the vehicle speed relatively increases. Therefore, the behavior of the vehicle 2 tends to be larger as the vehicle speed relatively increases even with at equivalent lateral braking force difference change rate.

On the other hand, the braking force control device 1401 configured in the above-described manner sets the change rate upper limit of the lateral braking force difference change rate to a lower value as the vehicle speed is higher. As a result, the braking force control device 1401 can inhibit an allowable lateral braking force difference change rate in braking force distribution control as the behavior sensitivity of the vehicle 2 becomes relatively high and can increase the allowable lateral braking force difference change rate as the behavior sensitivity of the vehicle 2 relatively decreases. Therefore, the braking force control device 1401 can substantially equivalently inhibit change in behavior of the vehicle 2 due to unintended braking force difference from a high-speed driving region in which the behavior sensitivity of the vehicle 2 is relatively high to a low-speed driving region in which the behavior sensitivity is relatively low, thereby realizing equivalent driving feeling.

### Fifth Embodiment

FIG. 7 is a diagram illustrating an example of a change rate upper limit map of a braking force control device according to a fifth embodiment. The braking force control device according to the fifth embodiment is different from that of the first to fourth embodiments in that a change rate upper limit is changed according to a change rate of lateral motion of a vehicle.

An ECU 8 of a braking force control device 1501 according to this embodiment (refer to FIG. 1) changes the change rate upper limit according to the change rate of the lateral motion of a vehicle 2. In this embodiment, the change rate upper limit set for a lateral braking force difference change rate of a left rear wheel 3RL and a right rear wheel 3RR is set so as to be higher as the change rate of the lateral motion of the vehicle 2 is higher. Herein, a yaw rate of the vehicle 2 detected by a yaw rate sensor 15, lateral acceleration of the vehicle 2 detected by a lateral acceleration sensor 16, a rudder angle of the vehicle 2 detected by a rudder angle sensor 17 and the like can be used, for example, as an index indicating magnitude of the lateral motion of the vehicle 2. An index indicating the change rate of the lateral motion of the vehicle 2 corresponds to change amounts of the yaw rate, the lateral acceleration, or the rudder angle per unit time.

A change rate upper limit map m104 illustrated in FIG. 7 is a map for setting the change rate upper limit (threshold value D1) in which the index indicating the change rate of the lateral motion of the vehicle 2 (a yaw rate change rate (dYr), a lateral acceleration change rate (dGy), or a rudder angle change rate (d rudder angle)) is plotted along the abscissa and the change rate upper limit set for the lateral braking force difference change rate is plotted along the ordinate. The change rate upper limit map m104 represents relationship between the index indicating the change rate of the lateral motion and the change rate upper limit. The change rate upper limit map m104 in which the relationship between the index indicating the change rate of the lateral motion and the change rate upper limit is set in advance based on actual vehicle evaluation and the like is stored in a storage unit of the ECU 8. In this change rate upper limit map m104, the change rate upper limit increases as the index indicating the change rate of the lateral motion increases. The ECU 8 calculates the change rate upper limit of the lateral braking force difference change rate from the yaw rate of the vehicle 2 detected by the yaw rate sensor 15, the lateral acceleration of the vehicle 2 detected by the lateral acceleration sensor 16, or the rudder angle of the vehicle 2 detected by the rudder angle sensor 17 based on the change rate upper limit map m104. According to this, the ECU 8 can make the change rate upper limit of the lateral braking force difference change rate higher as the change rate of the lateral motion of the vehicle 2 is higher.

Herein, appropriate braking force distribution can be realized even during a turn of the vehicle 2 as an advantage of braking force distribution control to control braking force of a left rear wheel 3RL and a right rear wheel 3RR such that slip ratios of the left rear wheel 3RL and the right rear wheel 3RR are equivalent. According to this, in the vehicle 2, [outer wheel braking force>inner wheel braking force] is satisfied, for example, and a spin during the turn is inhibited. At that time, in the braking force control device 1501, vehicle stability might be inhibited at the time of braking while turning in which it is necessary to provide lateral braking force difference more quickly than in the case of straight travel by the change rate upper limit provided for the lateral braking force difference change rate in the braking force distribution control.

On the other hand, the braking force control device 1501 configured in the above-described manner sets the change rate upper limit of the lateral braking force difference change rate to a higher value as the change rate of the lateral motion of the vehicle 2 is higher when the vehicle 2 performs the lateral motion, for example. According to this, in the braking force control device 1501, when the change rate of the lateral motion of the vehicle 2 is relatively high, the upper limit of the lateral braking force difference change rate is set to a higher value than that in the case of the straight travel, so that this can provide the lateral braking force difference quickly in response to quick change in behavior occurring at the time of the braking while turning and the like. As a result, the braking force control device 1501 can quickly provide the lateral braking force difference while allowing a necessary lateral braking force difference change rate in response to the change in behavior of the vehicle 2 at the time of the braking while turning and the like and minimize occurrence of disturbance of the behavior of the vehicle 2 due to the unintended lateral braking force difference at the time of braking while traveling straight and the like.

### Sixth Embodiment

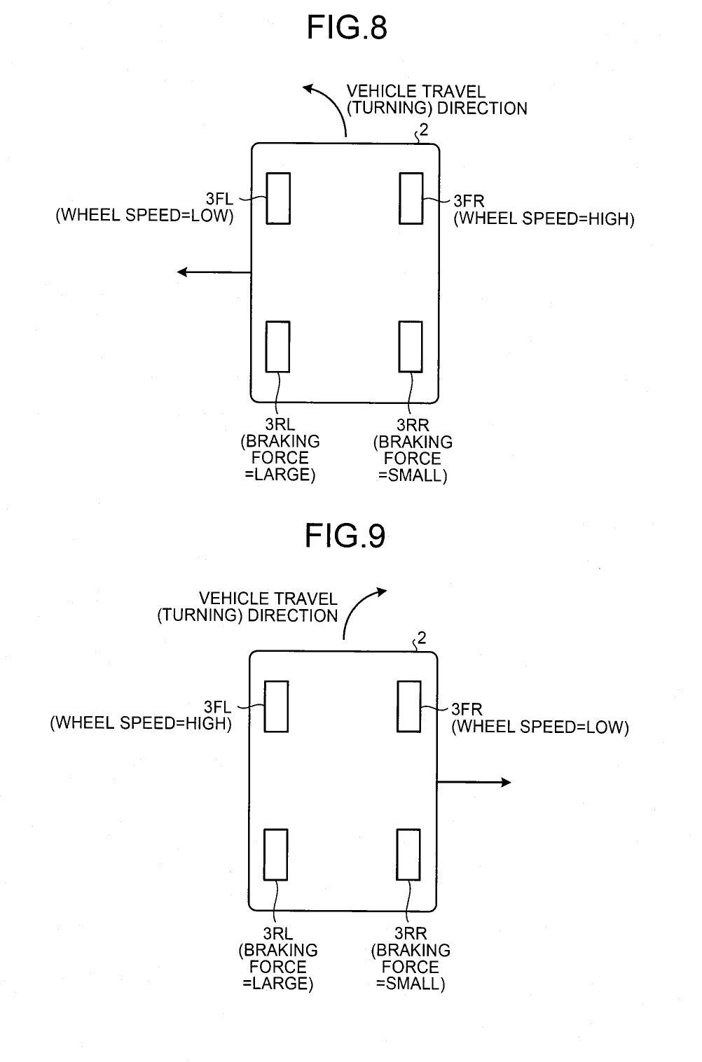

FIGS. 8 and 9 are schematic diagrams for illustrating a change rate upper limit of a braking force control device according to a sixth embodiment. A method of setting the change rate upper limit of the braking force control device according to the sixth embodiment is different from that of the first to fifth embodiments.

An ECU 8 of a braking force control device 1601 according to this embodiment (refer to FIG. 1) sets the change rate upper limit of a lateral braking force difference change rate according to magnitude relationship between braking force of a left rear wheel 3RL and that of a right rear wheel 3RR based on a detection result of a wheel cylinder pressure sensor 19 and the like.

That is to say, the ECU 8 sets such that the change rate upper limit of the lateral braking force difference change rate is relatively low when a wheel on a side on which the braking force is larger out of the left rear wheel 3RL and the right rear wheel 3RR (left rear wheel 3RL in an example in FIG. 8) is the wheel on a side in the same direction as a direction of lateral motion of a vehicle 2 as illustrated in FIG. 8. In the vehicle 2, the lateral motion tends to be promoted when the wheel on the side on which the braking force is larger out of the left rear wheel 3RL and the right rear wheel 3RR is the wheel on the side in the same direction as the direction of the lateral motion. Therefore, the ECU 8 can make the change rate upper limit relatively low when magnitude relationship between the braking force of the left rear wheel 3RL and that of the right rear wheel 3RR is relationship to promote the lateral motion of the vehicle 2, in more detail, when the motion of the vehicle 2 by the lateral braking force difference change rate is in a direction to make the lateral motion of the vehicle 2 larger.

On the other hand, the ECU 8 sets such that the change rate upper limit of the lateral braking force difference change rate is relatively high when the wheel on the side on which the braking force is larger out of the left rear wheel 3RL and the right rear wheel 3RR (left rear wheel 3RL in an example in FIG. 9) is the wheel on a side in a direction opposite to the direction of the lateral motion of the vehicle 2 as illustrated in FIG. 9. In the vehicle 2, the lateral motion tends to be canceled when the wheel on the side on which the braking force is larger out of the left rear wheel 3RL and the right rear wheel 3RR is the wheel on the side in the direction opposite to the direction of the lateral motion. Therefore, the ECU 8 can make the change rate upper limit of the lateral braking force difference change rate relatively high when the magnitude relationship between the braking force of the left rear wheel 3RL and that of the right rear wheel 3RR is relationship to cancel the lateral motion of the vehicle 2, in more detail, when the motion of the vehicle 2 by the lateral braking force difference change rate is in a direction to cancel the lateral motion of the vehicle 2.

Therefore, the braking force control device 1601 configured in the above-described manner can set the change rate upper limit of the lateral braking force difference change rate according to relationship between the direction of the lateral motion of the vehicle 2 by steering and a direction of change in behavior of the vehicle 2 due to lateral braking force difference when the vehicle 2 is steered after the braking thereof is started, for example. As a result, the braking force control device 1601 can sufficiently allow the lateral braking force difference change rate on a side on which the behavior of the vehicle 2 is stabilized, thereby quickly providing the lateral braking force difference. On the other hand, the braking force control device 1601 can certainly inhibit the lateral braking force difference change rate on a side on which the behavior of the vehicle 2 is not stable, thereby inhibiting the lateral braking force difference from being provided. According to this, the braking force control device 1601 can stabilize the behavior of the vehicle 2 more certainly by braking force distribution control even when there is large change in the behavior of the vehicle 2 after the braking is started such as when the vehicle 2 is steered after the braking thereof is started, for example.

### Seventh Embodiment

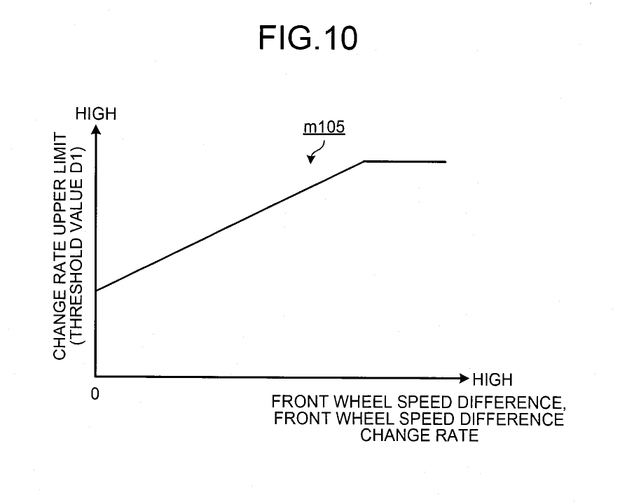

FIG. 10 is a diagram illustrating an example of a change rate upper limit map of a braking force control device according to a seventh embodiment. The braking force control device according to the seventh embodiment is different from that of the first to sixth embodiments in that a change rate upper limit is changed according to deviation of wheel speeds of right and left front wheels of a vehicle.

Wheels 3 of a vehicle 2 being a control target by braking force distribution control by a braking force control device 1701 according to this embodiment (refer to FIG. 1) are right and left rear wheels 3 of the vehicle 2, that is to say, a right rear wheel 3RR and a left rear wheel 3RL as described above. The ECU 8 changes the change rate upper limit of a lateral braking force difference change rate according to deviation of wheel speeds of right and left front wheels 3 of the vehicle 2, that is to say, a right front wheel 3FR and a left front wheel 3FL, herein, wheel speed difference (hereinafter, sometimes referred to as “front wheel speed difference”). In this embodiment, the change rate upper limit set for the lateral braking force difference change rate of the left rear wheel 3RL and the right rear wheel 3RR is set so as to be higher as the front wheel speed difference is larger or a change rate of the front wheel speed difference (hereinafter, sometimes referred to as “front wheel speed difference change rate”) is higher.

A change rate upper limit map m105 illustrated in FIG. 10 is a map for setting the change rate upper limit (threshold value D1) in which the front wheel speed difference or the front wheel speed difference change rate is plotted along the abscissa and the change rate upper limit set for the lateral braking force difference change rate is plotted along the ordinate. The change rate upper limit map m105 represents relationship between the front wheel speed difference or the front wheel speed difference change rate and the change rate upper limit. The change rate upper limit map m105 in which the relationship between the front wheel speed difference or the front wheel speed difference change rate and the change rate upper limit is set in advance based on actual vehicle evaluation and the like is stored in a storage unit of the ECU 8. In the change rate upper limit map m105, the change rate upper limit increases as the front wheel speed difference or the front wheel speed difference change rate increases. The ECU 8 calculates the change rate upper limit of the lateral braking force difference change rate from the wheel speed detected by each wheel speed sensor 13 of the left front wheel 3FL and the right front wheel 3FR based on the change rate upper limit map m105. According to this, the ECU 8 can make the change rate upper limit of the lateral braking force difference change rate higher as the front wheel speed difference is larger or the front wheel speed difference change rate is higher.

Herein, in the vehicle 2, the front wheel speed difference tends to be relatively large or the front wheel speed difference change rate tends to be relatively high when grounded load difference between the right and left wheels 3 is relatively large or when change in behavior of the vehicle 2 is larger when the vehicle body quickly deviates.

On the other hand, the braking force control device 1701 configured in the above-described manner sets the change rate upper limit of the lateral braking force difference change rate to a higher value as the front wheel speed difference is larger or the front wheel speed difference change rate is higher, for example. According to this, the braking force control device 1701 can allow relatively high lateral braking force difference change rate thereby quickly providing lateral braking force difference as needed when grounded load difference between the right and left wheels 3 is relatively large or when change in behavior of the vehicle 2 is larger. As a result, the braking force control device 1701 can quickly provide the lateral braking force difference while allowing a necessary lateral braking force difference change rate when the grounded load difference between the right and left wheels 3 is relatively large or when the change in behavior of the vehicle 2 is large, and minimize disturbance of the behavior of the vehicle 2 due to unintended lateral braking force difference when this is not necessary.

Meanwhile, the braking force control device according to the above-described embodiments of the present invention is not limited to the above-described embodiments and can be variously changed within the scope of claims. The braking force control device according to this embodiment may be formed by appropriately combining the components of the above-described embodiments.

Although the control device of the braking force control device is described above to be the ECU controlling each unit of the vehicle, there is no limitation, and this may also be configured separately from the ECU to transfer information such as a detection signal, a driving signal, a control instruction and the like to/from the ECU, for example.

Although it is described above that the control device uses difference in braking force between the right and left wheels as the lateral braking force deviation, there is no limitation, and this may also use a ratio of the braking force of the right and left wheels (for example, braking force of one wheel/braking force of the other wheel), for example.

### REFERENCE SIGNS LIST

1001, 1201, 1301, 1401, 1501, 1601, 1701 BRAKING FORCE CONTROL DEVICE
2 VEHICLE
3 WHEEL
3RR RIGHT REAR WHEEL
3FR RIGHT FRONT WHEEL
3RL LEFT REAR WHEEL
3FL LEFT FRONT WHEEL
7 BRAKING DEVICE
8 ECU (CONTROL DEVICE)

1-10. (canceled)

11. A braking force control device comprising:
a braking device capable of individually adjusting braking force generated at each wheel of a vehicle; and
a control device capable of executing braking force distribution control to individually control the braking force of each of right and left wheels such that slip states of the right and left wheels of the vehicle become equivalent by controlling the braking device, wherein
the control device executes the braking force distribution control based on a change rate upper limit of a change rate of lateral braking force deviation which is deviation of the braking force of the right and left wheels.

12. The braking force control device according to claim 11, wherein
the control device gives priority to control to decrease the braking force of the right and left wheels over control to increase the braking force of the right and left wheels, at the time the change rate of the lateral braking force deviation is higher than the change rate upper limit in the braking force distribution control.

13. The braking force control device according to claim 11, wherein
the control device gives priority to control to increase the braking force of the right and left wheels over control to decrease the braking force of the right and left wheels, at the time the change rate of the lateral braking force deviation is higher than the change rate upper limit in the braking force distribution control.

14. The braking force control device according to claim 11, wherein
the change rate upper limit is lower as deceleration of the vehicle is higher.

15. The braking force control device according to claim 12, wherein
the change rate upper limit is lower as deceleration of the vehicle is higher.

16. The braking force control device according to claim 13, wherein
the change rate upper limit is lower as deceleration of the vehicle is higher.

17. The braking force control device according to claim 11, wherein
the change rate upper limit is higher as a change rate of the deceleration of the vehicle is higher.

18. The braking force control device according to claim 12, wherein
the change rate upper limit is higher as a change rate of the deceleration of the vehicle is higher.

19. The braking force control device according to claim 13, wherein
the change rate upper limit is higher as a change rate of the deceleration of the vehicle is higher.

20. The braking force control device according to claim 14, wherein
the change rate upper limit is higher as a change rate of the deceleration of the vehicle is higher.

21. The braking force control device according to claim 11, wherein
the change rate upper limit is lower as a travel speed of the vehicle is higher.

22. The braking force control device according to claim 12, wherein
the change rate upper limit is lower as a travel speed of the vehicle is higher.

23. The braking force control device according to claim 13, wherein
the change rate upper limit is lower as a travel speed of the vehicle is higher.

24. The braking force control device according to claim 14, wherein
the change rate upper limit is lower as a travel speed of the vehicle is higher.

25. The braking force control device according to claim 17, wherein
the change rate upper limit is lower as a travel speed of the vehicle is higher.

26. The braking force control device according to claim 11, wherein
the change rate upper limit is higher as a change rate of lateral motion of the vehicle is higher.

27. The braking force control device according to claim 12, wherein
the change rate upper limit is higher as a change rate of lateral motion of the vehicle is higher.

28. The braking force control device according to claim 11, wherein
the change rate upper limit is relatively low at the time a wheel on a side on which the braking force is larger out of the right and left wheels is a wheel on a side in the same direction as a direction of the lateral motion of the vehicle, and is relatively high at the time the wheel on the side on which the braking force is larger out of the right and left wheels is a wheel on a side in a direction opposite to the direction of the lateral motion of the vehicle.

29. The braking force control device according to claim 11, wherein
the change rate upper limit is relatively high at the time motion of the vehicle by the change rate of the lateral braking force deviation is in a direction to cancel the lateral motion of the vehicle, and is relatively low at the time the motion of the vehicle by the change rate of the lateral braking force deviation is in a direction to make the lateral motion of the vehicle larger.

30. The braking force control device according to claim 11, wherein
a wheel of the vehicle which is a control target by the braking force distribution control is the right and left rear wheels of the vehicle, and
the change rate upper limit is higher as deviation of wheel speeds of the right and left front wheels of the vehicle is larger or a change rate of the deviation of the wheel speeds is higher.
